(19) United States
(12) Patent Application Publication
(10) Pub. No.: US 2010/0013343 A1
(43) Pub. Date: Jan. 21, 2010

(54) CONSTANT FREQUENCY AND LOCKED PHASE GENERATOR ADAPTABLE TO VARIABLE TORQUE

(76) Inventor: Dachuan Bi, Beijing (CN)

Correspondence Address: MORRISON & FOERSTER, LLP, 555 WEST FIFTH STREET, SUITE 3500, LOS ANGELES, CA, 90013-1024, US

(21) Appl. No.: 12/519,752

(22) PCT Filed: Jan. 22, 2007
(86) PCT No.: PCT/CN07/00227

§ 371 Date: Aug. 28, 2009

(30) Foreign Application Priority Data
Dec. 18, 2006 (CN) 200610165306.3

(51) Int. Cl. H02K 23/36; H02K 7/09; F03D 9/00

(52) U.S. Cl. 310/198; 310/90.5; 290/55

(57) ABSTRACT

This invention relates to a bearingless constant frequency phase locked generator adaptable of variable torque. With a reasonable combination of rotor poles and stator poles configured with U type permanent magnets and windings respectively, this novel generator can, with no need for acceleration of gearbox and sequential electrical controls, produce constant frequency constant voltage output, and is capable of auto phase (of the grid, for example) tracing and/or locking through the electrical control of the turn on/off of individual stator windings. Further a bearingless design is adopted and initiative suppression of axis vibration can be achieved. This generator has a relative simple structure, lower cost and high wind energy conversion, and is adaptable for a wide range of wind speed. This generator can be connected to grid directly and is suitable for wind power generation and other applications.

### CROSS REFERENCE TO RELATED APPLICATIONS

This invention claims the benefit to Chinese patent application No. 200610165306.8, filed on Dec. 18, 2006, entitled “Constant Frequency and Locked Phase Generator Adaptable to Variable Torque”, the entire disclosure of which is incorporated herein by reference.

### FIELD OF THE INVENTION

This invention relates to generator, particularly to constant frequency phase locked generator adaptable to variable driving torque.

### BACKGROUND OF THE INVENTION

There are many grid-connected wind energy generation systems, most of which are referred to as variable speed constant frequency wind energy generator, typically comprising cage-type induction asynchronous generator, double-fed asynchronous generator, electrically excited synchronous generator, permanent magnet synchronous generator, transverse flux generator, etc. Most of the current wind generators available in industry have gearbox and electric controlling equipments; the frequency transformer and the related control system are complicated. Those systems always suffer from, for example, heavy mechanical wear, frequent system failure, expensive maintenance and high electric loss in addition to their high cost. Among others, although having relative high operation efficiency, permanent magnet synchronous generator is disadvantage in its extremely complex control based on full capacity converter and is not economical; in addition, such generator is inconvenient in its starting up.

Another kind of wind energy generator commonly referred to as constant speed and constant frequency system and characterized by constant rotation speed of rotor mainly comprises synchronous generator, cage-type asynchronous generator, wound rotor RCC asynchronous generator, etc. These generators have relative simple structures but have drawbacks such as poor wind energy conversion, susceptive to mechanical impetus, etc, and therefore are less used in large scaled grid-connected circumstance.

At present, almost all of the wind generators widely used in industry cannot be connected to grid directly, on the contrary they must resort to some complicated electric equipments to grid indirectly. Generally, in order to achieve generator-to-grid connection, the three phase AC voltage outputted from generator and the grid voltage should meet the following conditions: identical phase sequence, identical amplitude, identical frequency, and identical phase.

Although permanent magnet generators based on U type permanent magnet material have been utilized in practice, their magnetic field utility is typically unfavorable due to large vortex drag in stator caused by flux of U type magnet. The present applicant has proposed a highly energy-saving structure in Chinese patent, entitled “A permanent magnetic full compensation type magnetic suspension structure” (Application No.: 200510015618.8), which can form a quasi-closed magnetic circuit and thus has high magnetic efficiency, small vortex drag, and thus can achieve favorable magnetic field utilization.

Based on the related study on U type structure and with the compliance of the aforementioned basic conditions for generator-to-grid connection, the present provides a convenient solution for direct generator-to-grid connection.

In view of the drawbacks of the wind generators used in industry, the present invention intends to simplify the structure of wind generator and improve its system efficiency. Taking account of the design criterion of 3-phase supply system, this generator makes use of U type wide-temperature neodymium-iron-boron permanent magnet and windings instead of gearbox for acceleration to achieve frequency stabilization and phase locking by being controlled by only electric components. Direct generator-to-grid connection and auto frequency and phase (e.g., of the grid) tracking can be accomplished. The tedious subsequent electrical controls are removed and thus the related losses can be avoided. Further, with a low noise bearingless construction, the generator can suppress shaft vibration initiatively. As a system combining both generator and electronics, it can be extended to other applications as well.

### THE DESCRIPTION OF DRAWINGS

FIG. 1 is a schematic diagram showing concentric circle models of rotor and stator;

FIG. 2 is a schematic diagram of the rotor poles and the stator poles in accordance with the present invention;

FIG. 3 is a schematic diagram illustrating the generation of 3-phase AC in accordance with the present invention;

FIG. 4 shows an array arrangement in accordance with the present invention; and

FIG. 5 is a schematic diagram of the magnetic suspension structure of the generator according to the present invention.

### DETAILED DESCRIPTION OF THE INVENTION

The principle of this invention as well as various advantages thereof can be better understood by those skilled in the art from the following description of a preferred embodiment of this invention. However, it is appreciated that this invention is not limited to the disclosure of the embodiment.

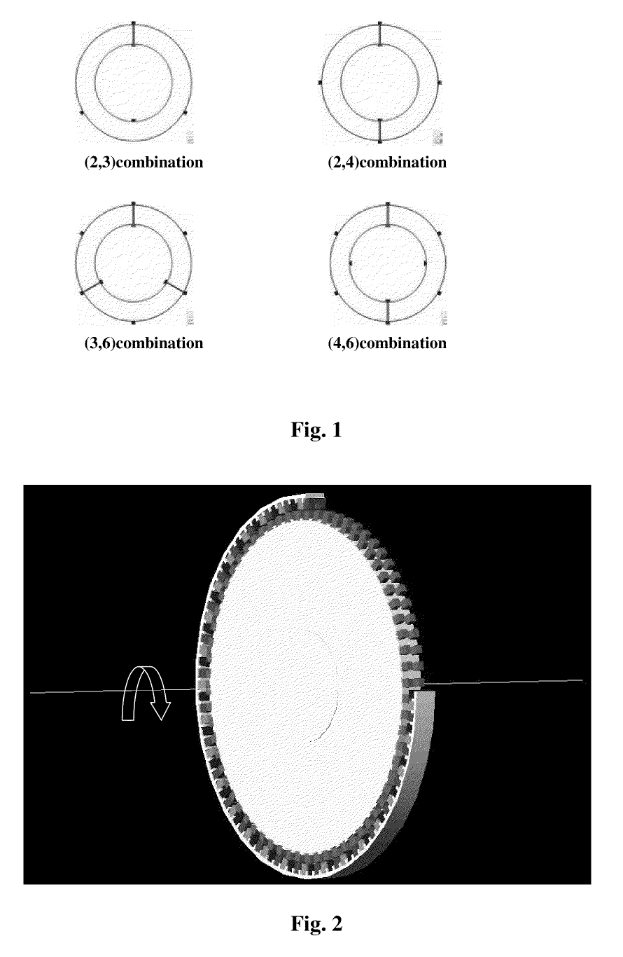

FIG. 1 shows the starting point of generator design according to this invention, which is adaptable to variable torque by means of a reasonable stator pole and rotor pole combination rather than the speed regulation of gearbox. First, a simplest geometric diagram is considered, in which several points each representing a pole are uniformly distributed on two concentric circles. Assuming that there are m points on the inner circle (the rotor) and n points on the outer circle (the stator) to simulate a structure of generator. According to a general generator model, the outer circle is fixed while the inner circle rotates in clockwise direction. Conceptually, during the rotation of the rotor, a “meeting” of the rotor and the stator will occur when there is at least one pair of points on the inner circle and the outer circle so that the connection line therebetween runs through the center of the concentric circles. For each meeting, the number of the pairs is refers to as coupling rate, and the number of meetings that occurs per round of the rotor is referred to as magnification.

It can be seen from FIG. 1, as for the rotor-stator combinations (2,3), (2,4), (3,6) and (4,6), the corresponding magnifications are 6, 4, 6, 12 respectively, and the corresponding coupling rates are 1, 2, 3, 2 respectively. Considering that each meeting of the rotor and the stator may cause action of force between the rotor and the stator, making an impact on the rotor and thus its axis inevitably, it is straightforward that the rotation of the rotor can not be kept on stable, and the axis may be damaged substantially if only level 1 coupling (coupling rate 1) may occur for a specific rotor-stator combination (m, n); for the case of level 2 or higher level coupling for the combination (m, n), it is possible to make the resultant force in rotor plane to zero in order to minimize influence on the rotation by reasonable structure design and operation controls.

If the rotor driven by an outside torque rotates at speed r, and the frequency of the output current is f (50 Hz in the case of grid-connection, for instance), assuming that each meeting of the rotor and the stator may induce and only induce one complete sine or cosine wave, the magnification required to be achieved will be approximately f/r. Some corresponding revisions will be given in the following description with respect to the generation of 3-phase AC.

Taking the rotor-stator combination (66,99) as an example, FIG. 2 shows a schematic diagram of the rotor poles and stator poles of the generator according to this invention. In this generator, each pole of the inner rotor comprises a U type structure made of two separate wide-temperature neodymium iron boron permanent magnets, and each pole of the outer stator comprises a coil winding wrapped around a U type yoke in a certain manner. Further, all the windings may be coil-rounded in the same manner and in same number of turns. The U plane of each U type structure is perpendicular to the circle plane of the rotor and the stator as shown in FIG. 2, all the centerlines run through the center of the circle. The present applicant has proposed in the invention “A permanent magnetic full compensation type magnetic suspension structure” (Application No.: 200510015618.8) a specific solution aimed at reducing vortex drag and improving magnetic efficiency, wherein closed magnetic circuits can be formed by the rotor and the stator to improve the magnetic field utilization.

The U type permanent magnet structure and the arrangement thereof, together with the connection manner of the U type windings ensure that the stator can output complete and continuous sine or cosine AC waves. Further each of the windings can be provided with an electrical switch to control its on/off status electrically and flexibly.

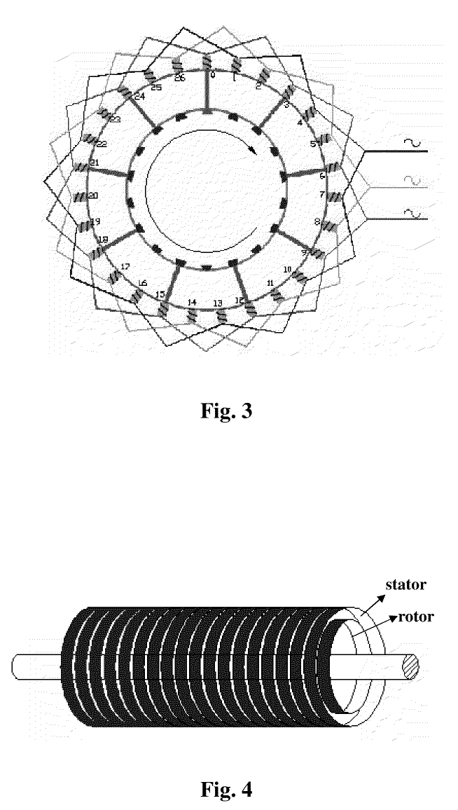

FIG. 3 schematically shows the 3-phase AC generation in accordance with this invention, taking a rotor-stator combination (18, 27) as an example. It can be seen from the meeting pattern of the rotor and the stator during the clockwise rotation of the rotor, the coupling rate is 9, that is, there are nine pairs of rotor pole and stator pole meeting each other respectively for any meeting instant. For the meeting instant shown in FIG. 3, the corresponding stators involved in that meeting are 0, 3, 6, . . . , 24, and for the next meeting the corresponding ones will change to 2, 5, 8, . . . , 26, for the third meeting 1, 4, 7, . . . , 25, and for the fourth meeting, it will change back to 0, 3, 6, . . . , 24 again and so on. Taking the assumption said above, that is, each stator pole generates a complete sine or cosine wave with period T for one meeting (which is possible according to an appropriate structure design), with a reasonable arrangement of the rotor poles and stator poles to set the time interval between two sequential meetings to T/3, it can be seen that the phase difference of current between stator poles 0, 3, 6, . . . , 24; 2, 5, 8, . . . , 26; and 1, 4, 7, . . . 25 is just 120° , and the current keeps to synchronous every other three stator poles. Thus the stator windings 0, 3, 6, . . . , 24 can be paralleled to form one phase of the 3-phase supply, similarly, the stator windings 2, 5, 8, . . . , 26 and the stator windings 1, 4, 7, . . . 25 can be paralleled respectively to form the other two phases.

Obviously, the present invention is not limited to such a combination (18, 27), any combination satisfying 3-phase design requirement is applicable. Theoretically, all combinations of m, n that satisfy m/n=2/3 can meet the requirements. Of course, other combinations instead of m/n=2/3 are also acceptable for this invention.

Furthermore, any sequential three windings can be grouped and used as single 3-phase supply separately. Two groups, three groups or more groups are also possible. For example, with the combination (18, 27), up to 9 groups of such supply can be connected in parallel. No matter how many groups are paralleled in case of constant rotation of rotor, the 3-phase voltage is constant, and the current flowing through respective windings does not vary in the case of unvaried load, but the total output current are multiplied many times. On the other hand, symmetric group selection may be adopted, that is, considering substantively symmetric positions so as to take a plurality of groups of 3-phase supplies to be paralleled connected so that result force of respective rotor-stator forces onto the rotor axis is zero. Since it is 3-phase supply, the magnification can be reduced to one-third of the theoretical value.

Based on such a 3-phase design, by applying AC to the stator externally, generator may function as a motor, which is suitable for situations that external driving is necessary in order to start up the generator.

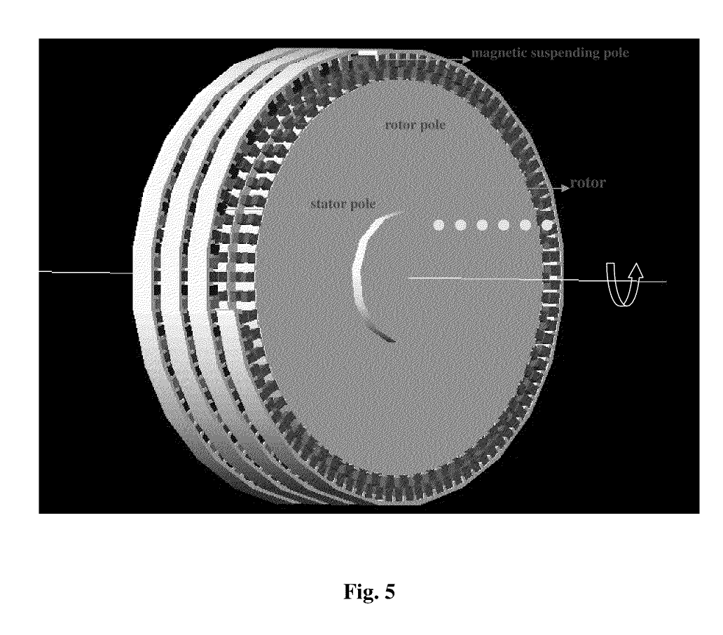

FIG. 4 shows an array type of generator arrangement according to this invention. As shown in the figure, a plurality of rotor-stator plates as described above are assembled in array in the axial direction, so that taking the advantage of 3-phase design principle said above, it is possible to achieve frequency modulation and phase modulation of generator itself as illustrated hereinafter.

Taking again, but not limited to, the rotor-stator combination (66, 99) that satisfies 3-phase supply requirements as an example, for single rotor-stator plate structure without multi-layer arrangement in axial direction, up to 33 levels of current change can be obtained for the same load by means of the control of the on/off status of different stator windings. On the other hand, when adding additional layers, such as 18-layers for example, to form a multi-layer arrangement in the axial direction, total 594 winding current change levels can be expected. Thus resorting to sensitive electric control and exact mechanical structure, it is possible to control the on/off status of different windings to refine the total current output of the paralleled windings according to the torque moment inputted from the rotor, and thus regulating the tangential drag applied on the rotor poles by the stator to maintain constant rotation speed of rotor, hold a constant voltage and then adjust power output of the generator. This can be achieved by an electric or electronic control system controlling the on/off status of electronic switching elements provided for different windings to hold the rotation speed of rotor constant.

In the context of such a design, the frequency of the output current of the generator is in proportion to the rotation speed of the rotor, in order to hold a constant speed of the rotor which is subjected to different input moments (corresponding to different wind levels for wind power generation applications), it depends on the number of the ON stator windings. If the frequency of the output current detected by the electronic control system is slightly lower than a required frequency, indicating that the speed of the rotor is slightly slower, the control system then correspondingly reduce the number of the ON stator windings according to the amount of deviation; and it may increase the number of the ON stator windings vice versa. Similar principle may be applied to the phase modulation. Under the condition of satisfying a required output current frequency, if there is a phase lag in relation to a required phase, the number of the ON stator windings shall be reduced to by a fine adjustment; and it may be increased by a fine adjustment vice versa. As a general guide for frequency modulation and phase modulation, the frequency is modulated by exact adjustment and the phase is modulated by fine adjustment.

Under the condition that the rotation speed of the rotor is constant for a constant load, the copper loss is low due to the constant current in individual stator windings. Multi-level current change is possible by a particular selection of combination (m, n), as well as the number of the layers in the rotor-stator plate array. The wider range of the current change, the broader moments the generator is adaptable (wider wind speed range in a wind power generation).

FIG. 5 shows a magnetic suspension structure on the basis of the rotor-stator plate array according to this invention. Referring again to the combination of rotor-pole-number and stator-pole-number, (66, 99), as a preferable embodiment. U type permanent magnet structure is used to substitute the stator winding poles to take advantage of the strong magnetism of the permanent magnet of rotor, or magnetic suspension plate(s) is used to substitute rotor-stator plate(s) of the original structure, (that is, replacing all the stator poles of certain rotor-stator plate(s) with permanent magnets). As shown in the figure, same polarity portions are disposed opposite to each other so that the rotor is fixed onto the axis by repulsion. In view of the gravity of the rotor, the lower magnets in the magnetic suspension structures are thicker than the upper ones or they can use different permanent magnets with stronger magnetism so that sufficient repulsion can be generated against the affect on the magnetic suspending resulted from gravity of the rotor.

Depending on the above analysis, besides the accurate calculation and refined design of rotor and stator, rotor vibration can be controlled initiatively, for example, by means of the stator windings. For example, the tendency of rotor vibration can be determined by a measurement system, based on which an asymmetric ON-selection of stator windings can be made, that is, selectively turning on specific stator pole windings on certain rotor-stator plate(s), to produce an additional drag torque against the unbalance of the rotors, making the axial, the radical and the tangential resultant force zero respectively to keep the stability of the rotors. It needs not to say that such a regulation process shall be implemented on the premise of not disturbing the frequency stabilization and phase locking. Such a bearingless design has advantages such as high mechanical efficiency and low noise.

Obviously, such a bearingless constant frequency phase-locked generator is adaptable for variable moment can find its various applications in many aspects.

In summary the generator of the present invention has the following features and/or advantages:

a) with a reasonable configuration of U type permanent magnets on rotor and U type winding structures on stator, closed magnetic circuits can be formed between rotor poles and stator poles, which can improve the magnetic field utilization;

b) with an appropriate combination of rotor poles and stator poles, frequency scalability can be achieved inherently without the support of gearbox;

c) grid frequency and phase tracing can be implemented by electrically controlling the number of windings to be turn on simultaneously, further, substantial constant rotation speed and constant output voltage can be obtained, and direct grid-connection can be achieved with no need for additional electric controls;

d) if load is not changed, since individual windings have constant currents, copper loss is low, the range of adaptable input torques may be widened with the increase of the number of adjustable current levels (that is, a larger range of adaptable wind speeds than that of a conventional wind generator can be achieved);

e) with a bearingless structure, the gravity of the rotor may be involved in design, and rotor vibration can be controlled initiatively;

f) starting up the generator easily. If external driving is necessary to start up the generator, it can be switched to a motor to do so;

g) since gearbox and specific electric equipments are removed and a bearingless structure is adopted, the wind energy conversion may be expected to a new high;

h) the whole structure is simple and the cost is low.

Many modifications and alternatives can be made to this invention, and the details given by embodiments and shown in the accompanying drawings are only for the purpose of illustration. The present invention is not limited to the particular disclosure described above, but rather will encompass all the modifications, alternatives and equivalents falling without departing from the spirit and scope of the invention defined by the following claims.

What is claimed is:

1. A constant-frequency phase-locked generator adaptable of variable torque, comprising a rotor consisting of U type permanent magnets and a stator consisting of U type windings to form closed magnetic circuits therebetween, wherein a specific combination of the number of rotor poles and the number of stator poles is determined to meet three phase power requirements, each winding is provided with a electric switching element which is controlled by a electric or electronic control system to control turn on and turn off.

2. The constant-frequency phase-locked generator adaptable of variable torque according to claim 1, wherein the U-plane of the respective U type magnet is perpendicular to the circle plane the rotor and the stator disposed, the central lines of which running through the center of the circle.

3. The constant-frequency phase-locked generator adaptable of variable torque according to claim 1, wherein the combination of the number of rotor poles (m) and the number of stator poles (n) is typically selected as m/n=2/3.

4. The constant-frequency phase-locked generator adaptable of variable torque according to claim 1, wherein the stator pole windings are distributed uniformly, and the electrical angle between two sequential windings is 120 degree.

5. The constant-frequency phase-locked generator adaptable of variable torque according to claim 1, wherein the U type permanent magnets are wide-temperature neodymium iron boron permanent magnets.

6. The constant-frequency phase-locked generator adaptable of variable torque according to any of claim 1 to claim 5, wherein a plurality layers of rotor-stator plates are arranged in an array in the axial direction.

7. The constant-frequency phase-locked generator adaptable of variable torque according to claim 6, wherein frequency stabilization and phase locking for output current is implemented depending on how many stator windings is selected to be turned on.

8. The constant-frequency phase-locked generator adaptable of variable torque according to any of claim 1 to claim 5, wherein it is a bearingless structure in which the stator winding poles are substituted by U type permanent magnetic components, same polarities are disposed opposite each other so that the rotor is maintained along its axis by repulsion forces.

9. The constant-frequency phase-locked generator adaptable of variable torque according to claim 8, wherein the stator plate has permanent magnets with different thickness in its lower portion, or permanent magnets with different magnetism are used to produce sufficient repulsion force in resistance to the gravity of rotor.

10. The constant-frequency phase-locked generator adaptable of variable torque according to claim 8, wherein individual stator poles are selected to turn on asymmetrically to make an initiative control.
